(19) United States
(12) Patent Application Publication
(10) Pub. No.: US 2002/0120629 A1
(43) Pub. Date: Aug. 29, 2002

(54) Method and apparatus for information delivery on computer networks

(76) Inventor: Robert E. Leonard, Jupitor, FL (US)

Correspondence Address: SAMUEL BORODACH, Fish & Richardson P.C., Suite 2800, 45 Rockefeller Plaza, New York, NY, 10111, US

(21) Appl. No.: 10/085,901

(22) Filed: Feb. 27, 2002

Related U.S. Application Data
(63) Continuation of application No. 09/430,415, filed on Oct. 29, 1999.

(51) Int. Cl. G06F 7/00

(52) U.S. Cl. 707/100

(57) ABSTRACT

A method and apparatus for information delivery on computer networks is disclosed. Information such as electronic news stories and electronic advertisements is delivered based on geographical location and subject matter. News stories are displayed based on geography and subject on several client machines in unique geographical locations. Unique subject-matter and geographical identifiers are used to display the news stories on the client machines. Several advertisements are targeted to specific geographical locations based on unique geographical identifiers. Individual advertisements are displayed and refreshed based on the cost paid by the advertiser and the density of exposure requested by the advertiser.

This invention relates to the Internet and other global communications networks, and more particularly to a method and apparatus for delivery of data over the Internet and other global communications networks.

### BACKGROUND OF THE INVENTION

The Internet is a loose network of connected computers spread throughout the world. Data can be sent over the Internet through a series of computers (“nodes”) until it reaches its final destination computer. The World Wide Web (“WWW”) offers increasing amounts of information including images, articles, and other types of information which can be displayed on web pages. The information contained in these web pages is stored in numerous computers known as Web Servers. A software program called a “browser” can be used to access and display Web pages from the Internet by specifying the location of the web page. A programming language called HyperText Markup Language (“HTML”) is delivered to the browser. The desired web page is specified by a uniform resource locator (“URL”) indicating the location of the HTML file of interest.

Search engines on the Internet typically search and provide information based on key word or string matches within the search engine's database. If a user wants to search by geography, a key word/string search is used, such as “West Palm Beach”. In addition to finding information based on key word/string search, there are also subject and geographic specific Internet web sites. These sites provide information specific to either a specific geography, demography or subject. In some cases some Internet sites provide a specific combination of geography, demography and subject.

Servers for the web sites that provide these combinations of information are limited to the number of web sites that they can serve. The servers do not operate efficiently when the number of web sites increases into the order of hundreds. Since the web sites are geographically, demographically and/or subject specific, if multiple web sites are to be accessed through one server, such as news story web sites for cities across the United States, the server is limited to the actual number of web sites it can support.

Another limitation of these types of web site servers is that the advertising that is displayed is typically posted by large national advertisers.

### SUMMARY OF THE INVENTION

In general, the invention provides an improved method and apparatus for delivering information to web pages.

In one aspect, the invention features a computer-implemented electronic information delivery method, including providing a computer system adapted to be connected to a network, providing a database of information on the network, and providing a delivery engine on the computer, wherein the delivery engine delivers data from the database to the computer based on a user-selectable request.

In an implementation, the user-selectable request is a request for the information stored in the database and which is applicable for a geographical location.

In another implementation, the user-selectable request is a request for the information stored in the database and which is applicable for a particular subject.

In another implementation, information stored in the database is stored by at least one data structure, and the data structures are parent-child levels corresponding to various subjects.

In still another implementation, cookies planted on the computer from a information delivery software program geographic information on the computer according to the user-selectable request, and cookies are replanted if the user changes the user-selectable request.

In yet another implementation, information includes electronic news stories and other news-related electronic information, and electronic advertisements.

In another aspect, the invention features a computer-implemented method of displaying advertisements at a computer, including providing at least one advertisement on each displayed web page each time a user refreshes the web page, wherein each advertisement is retrieved from a database containing a plurality of advertisements, and selecting the displayed advertisements in accordance with a cost paid per impression and a density requirement.

In an implementation, providing an advertisement on the web page includes changing advertisements on the web page each time the web page is refreshed, wherein the displayed advertisements are alternated depending on the cost of the advertisement, the density of exposure of the advertisement, or the cost and density of exposure of the advertisement.

In another implementation the method includes delivering the advertisements to the computer according to the geographical location of the advertisement, delivering the advertisements to the computer according to a particular subject, or delivering the advertisements to the computer according to a geographical location of the computer and a particular subject.

In another implementation, the method also includes placing advertisements that have already been displayed into a data structure located in the database and retaining the advertisements in the data structure until the advertisements attain pre determined criterion, wherein the criterion is a product of the position in the data structure and a quantitative representation of the density of exposure.

In yet another aspect, the invention features a computer-implemented method of delivering selected electronic news stories from a database storing the stories to a computer for displaying the selected stories, including establishing a connection between the computer and the database through a network, delivering the selected stories from the database, wherein the stories are delivered according to user-selectable criteria including at least one geographic location data, and displaying the news stories on the computer.

In an implementation, one user-selectable criterion is a specification of at least one geographical location to which the news stories pertain, and another user-selectable criterion is a specification of at least one news story subject.

In another implementation, displaying the news stories on the computer further includes displaying a plurality of default news stories if there are no news stories that match to the user's identified user-selectable criteria.

In still another aspect, the invention features a computer program residing on a computer-readable medium comprising instructions for causing a computer system adapted to be connected to a network to provide a database of information on the network, provide a delivery engine on the computer, wherein the delivery engine delivers data from the database to the computer based on a user-selectable request.

In an implementation, the user-selectable request is a request for the information stored in the database and which is applicable for a geographical location or particular subject.

In another implementation, the information stored in the database is stored by at least one data structure comprising a plurality of parent-child levels corresponding to a plurality of subjects.

In another implementation, the program includes instructions to plant cookies on the computer from a information delivery software program geographic information on the computer according to the user-selectable request, wherein cookies are replanted if the user changes the user-selectable request.

In yet another implementation, the information includes electronic news stories and other news-related electronic information or electronic advertisements.

In another aspect, the invention features a processor-based apparatus including a processor, a first memory operationally coupled to the processor and a second memory operationally coupled to the processor, the memory storing instructions to provide information stored in the first memory to a network connected to the apparatus network, and deliver the information from the first memory to the network based on a user-selectable request.

In an implementation, the first memory is a database and the second memory is a hard disk.

Advantages can be provided by storing news stories organized first by geography, and then by subject within a database. A user can then access the database by geography and then be able to locate stories by subject within that geographical region. In this way, a single web site can be accessed from virtually any city in the world, and receive information specific to that local region from a single database. Advantages also include an advertiser's ability to target an Internet advertisement to a specific geographical region. Furthermore, a local advertiser can post an advertisement at the local web site and possibly override a national advertisement.

Other features and advantages will be readily apparent from the following description, the accompanying drawings, and the claims.

### BRIEF DESCRIPTION OF THE DRAWINGS

FIG. 1 illustrates a network device.

FIG. 2 illustrates prior art servers and clients connected to a network.

FIG. 3 illustrates an embodiment of a geo-subject information server connected to a network.

FIG. 4 illustrates a flow chart of an implementation of a geo-subject web site program flow.

FIG. 5 illustrates an implementation of a geo-subject data structure.

FIG. 6A illustrates a flow chart of an implementation of a floating news story method.

FIG. 6B illustrates a flow chart of another implementation of a floating news story method.

FIGS. 7A-7E illustrate implementations of a rotation method of a set of five advertisements in an exclude array.

FIGS. 8A-8E illustrate screen shots of implementations of a geo-subject web page.

### DETAILED DESCRIPTION

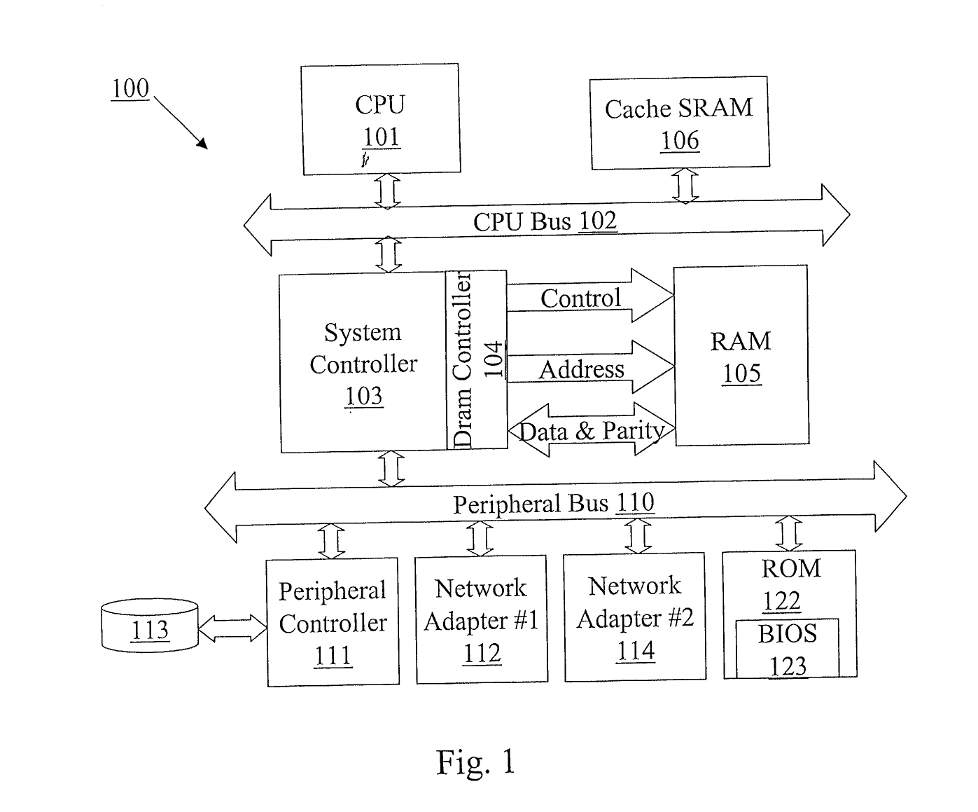

FIG. 1 depicts physical resources of an exemplary network device 100. The device 100 has a central processor 101 connected to a processor host bus 102 over which it provides data, address and control signals. The device also has a cache memory 106 for temporary storage of data. The processor 101 can be any conventional general purpose single- or multichip processor such as Pentium processor, a Pentium Pro processor, Pentium II processor, a MIPS processor, a Power PC processor or an ALPHA processor. In addition, the processor 101 may be any conventional special purpose processor such as a digital signal processor or a network communications protocol processor.

The device 100 includes a system controller 103 having an integrated RAM memory controller 104 connected to the host bus 102. The controller 103 provides an interface to random access memory 105. The system controller 103 also provides host bus to peripheral bus bridging functions. The controller 103 thereby permits signals on the processor host bus 102 to be compatibly exchanged with signals on a primary peripheral bus 110. The peripheral bus 110 can be, for example, a Peripheral Component Interconnect (PCI) bus, an Industry Standard Architecture (ISA) bus or Micro-Channel bus, or another bus structure. The device 100 may also include a first network adaptor 112 and a second network adaptor 114 coupled to the peripheral bus 110. The network adapters 112 and 114 may be for example, a modem, Ethernet card, or other network communications device for interface with a variety of networks such as the Internet. The device 100 may also include additional peripherals such as a hard disk drive control interface 111 to couple a hard disk 113 to the peripheral bus 110. The device 100 includes non-volatile ROM memory 122 to store basic computer software routines. ROM 122 can include alterable memory, such as EEPROM (Electronically Erasable Programmable Read only Memory), to store configuration data. ROM 122 can include software to test and initialize device hardware and can include a device operating system, and application software. BIOS routines 123 can be included in ROM 122 and provide basic computer initialization, systems testing, and input/output services.

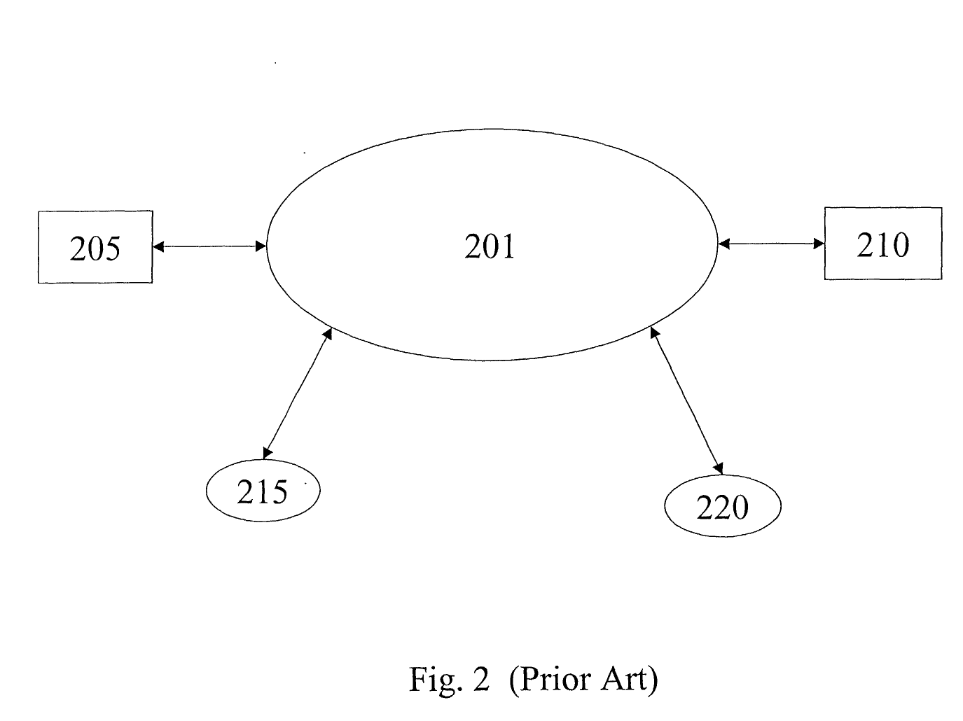

In a device 100 implementation, device 100 can be a server connected to the Internet providing news articles and advertisements to a variety of clients. FIG. 2 depicts a prior art server 205 connected to the Internet 201. A client device 210 can request a search to be conducted using a browser, such as Internet Explorer or Netscape located on client device 210. Typically a client will contact an information delivery Web Site such as GoTo.com. If the client 210 performs a news search for articles in, for example, West Palm Beach, Goto.com will deliver the information based on the subject matter of interest. In order to target West Palm Beach Fla., the user of client 210 will have to enter a Key word search specifying “West Palm Beach Florida”. Goto.com can then locate a local news site 220 located in West Palm Beach and report that finding back to client 210. In another example, if the client 210 was searching for news in San Diego Calif., the information delivery site would return a link to a news server 215 located in San Diego.

### DELIVERY OF INFORMATION

In the embodiments set forth below, a new method of information delivery is discussed. This new method organizes and delivers information first by geography then by subject matter. For simplicity of discussion, this delivery method is referred to as geo-subject delivery. In an embodiment, the geo-subject delivery is performed through a geo-subject delivery web site that users can access to both download news stories and advertisements and have news stories and advertisements delivered to them. It is understood that other embodiments are not limited by this embodiment.

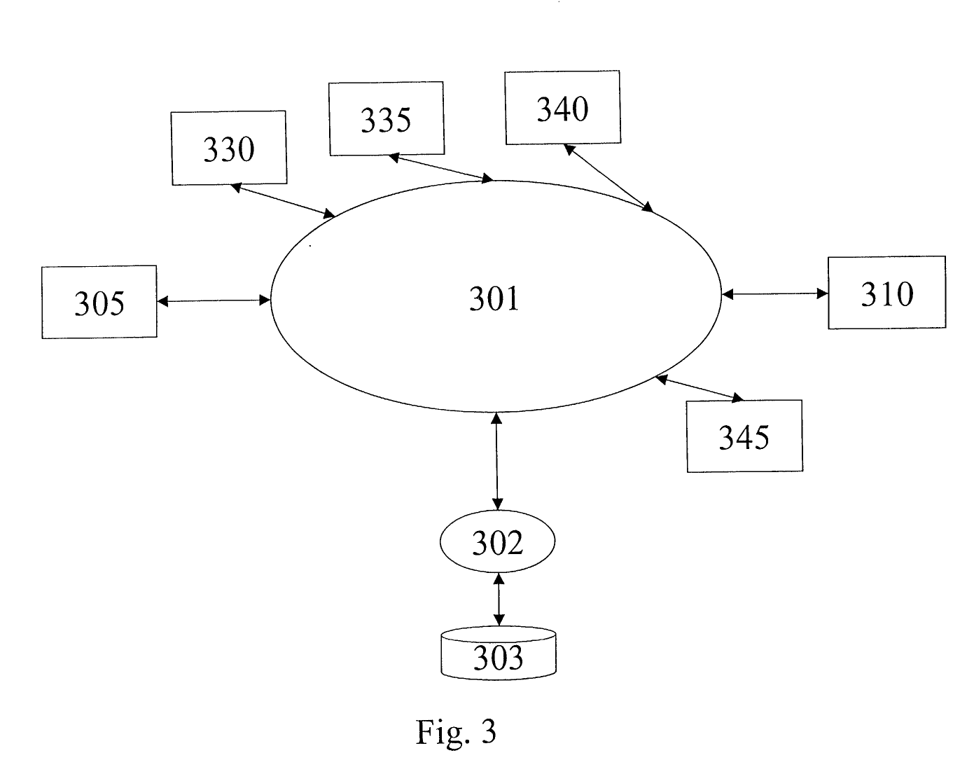

FIG. 3 illustrates an embodiment of a geo-subject information delivery system connected to a network 301. In this embodiment a client can contact a geo-subject based server 315 to search for news stories in virtually any part of the world. In this embodiment, any client computer 305-345 can access the geo-subject server 302 for information and have that information delivered to it. The geo-subject server 302 accesses geo-subject database 303 to deliver this information. Clients 305-345 can also download information to server 302 and store the information on database 303. The individual clients can request that the local geo-subject web page located on the client machine be the default local city of news interest. The geographical cookies are replanted to create the default page. Whenever the client then opens the geo-subject web page, the area selected by the client will be displayed. For example, a client in New York City initially accesses the geo-subject web site. The server delivers default information to the client. This default information can be National News and National advertisements. The New York City client may only be interested in news and advertisements local to the client. By setting the default geo-subject web page to New York City, the default news and advertisements that are displayed by the server 302 are New York City stories and advertisements. This default setting is achieved automatically when the user changes the default settings. The cookies that contain the geographic information are replanted to create these default settings. A client in Santa Fe can request its default geo-subject web page to display only news and advertisements local to Santa Fe, and the geographic cookies will automatically be replanted. In either of the examples discussed, all of the information is stored on a single geo-subject database 303. In an embodiment, the database 303 can be any custom database or any commercial database such as Oracle, Sybase or MicroSoft SQL Server.

### GEO-SUBJECT INFORMATION PROGRAM FLOW

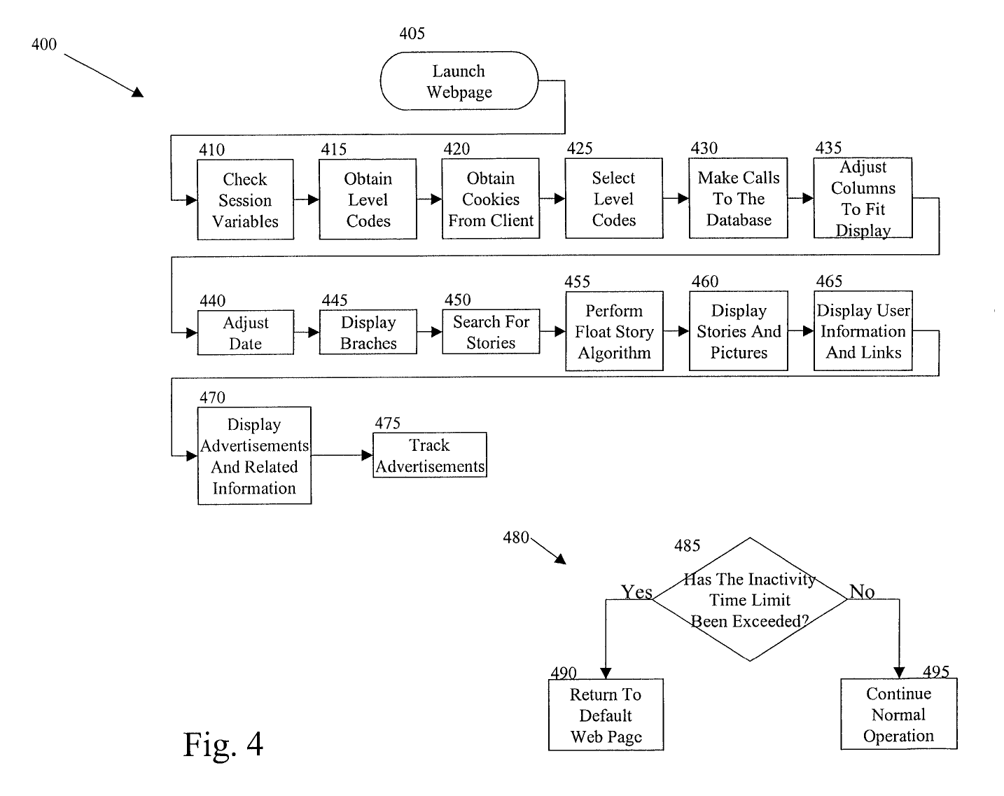

The program flow of the geo-subject delivery method is now discussed with reference to FIG. 4. After a user launches the geo-subject web page 405, the session variables are checked by the system at 410. The level codes that define the subject topography of the geo-subject web site are checked by the system at 415. The level system defined by the level codes and the associated advantages are discussed in more detail below. Next the cookies from the client are checked to determine the precise geographical location of the client at 420. The level codes are then selected from the geo-subject web page at 425, and the appropriate calls to the database are made at 430 to obtain the appropriate geo-subject information (including advertisement, news stories and other information) for display on the geo-subject web page. Since different clients will have different video displays, appropriate adjustments are made to the columns at 435 to fit the client display. The date is also appropriately adjusted by the system at 440. The different branches of news stories and information is displayed at 445. The branches are similar to the display of news sections in a typical newspaper. The stories to be displayed are searched at 450. Stories are then displayed at 455 according to a floating story algorithm which is described in more detail below. Once the algorithm is performed, the geo-subject news stories are displayed with any associated pictures at 460. In addition to the information, appropriate links and other user information are also displayed at 465. For example, the email address of the writer of a particular article can be displayed. URL links to other web pages can also be displayed if appropriate. If a writer wishes not to be contacted, the email address can be withheld. The geo-subject targeted advertisements are also displayed at 470. Advertisements are tacked at 475, that is, each advertisement impression is tracked at 475. Tracking is a process which can accumulate information such as where the advertisement was seen, under which subject the advertisement appeared, and the client Internet Protocol address. Every time a geo-subject web page is seen, the geo-subject information as well as the advertisements are stored in the database 303. This information is stored indefinitely until no longer deemed necessary or when database storage limits are exceeded. This information is important for marketing and accounting purposes. Such marketing purposes includes determining which pages users are using most. Accounting purposes include determining how many times an advertisement is displayed so that the advertiser can be appropriately charged. Any number of web tracking software packages, such as WebTrends can be used to track this information.

In an embodiment, a parallel process 480 checks to see if a time inactivity time out has been exceeded at 485. If the time limit has been exceeded, then the program loads the default web page at 490. If the time limit is not exceeded, then normal operation continues at 495.

### DELIVERY OF NEWS

As stated above, information is organized and delivered to the web page first geographically, and then by subject within a database. Virtually any combination of information can be delivered as indicated with many of the local city news delivery examples discussed above. An “all condition” delivery can also be achieved wherein, for example, all state-wide or county-wide news can be delivered to a geo-subject web site.

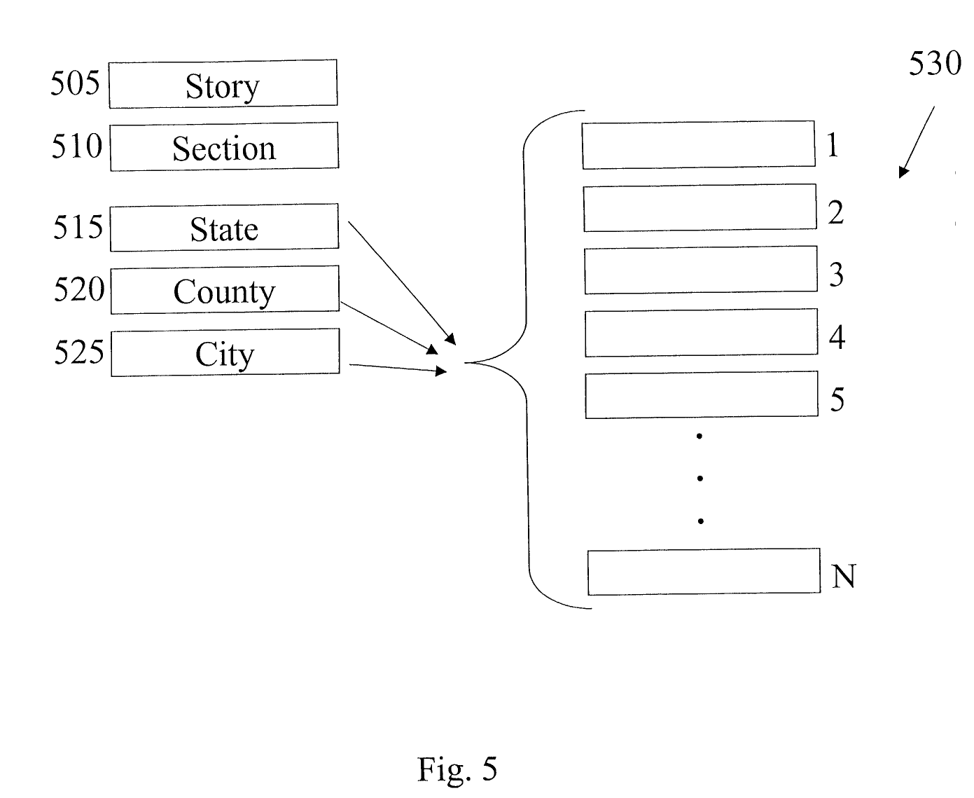

In an embodiment, a method using data structures in a database establishes “levels” of subject matter to organize information. FIG. 5 illustrates an embodiment of a organizational data structure for news stories. The figure illustrates the basic organizational structure in database 303. The following is a table showing the options for sorting and delivering the news stories from the database:

TABLE 1
Geographic Sorting

| | |
|---|---|
| Country | (optionally all countries) |
| State | (optionally all states) |
| County | (optionally all counties within a state) |
| City | (optionally all cities within a county) |

TABLE 2
Subject Sorting
Level 1
Level 2
Level 3
Level 4
Level 5
Level 6

FIG. 5 and the above table illustrate the organization of the geo-subject information in database 303. As discussed above, each client can have a local default geo-subject web page. Therefore, if a client is defaulted to receive local news at the geo-subject web page, then, when accessing the data base 303, the client is requesting local news. When a client requests a news story, identifiers (discussed below) associated with the story are passed to the database and a story is delivered to the geo-subject web page. In this embodiment, the data structure in the database is organized so that a particular story has a story identifier 505. The story also has state, county, and city identifiers 515, 520 and 525 respectively. These geography identifiers 515, 520, 525 enable the system to sort and deliver the news story by geography. Therefore, a story specific to a particular city is uniquely identified. For example, a story concerning the decision of the Mayor of Detroit is delivered to the geo-subject web page on a client located in Detroit which is requesting Detroit-specific information.

Referring still to FIG. 5, the news stories are also organized by subject. In this embodiment, the database 303 can be organized by N levels of subject matter 530. By having such a level of organization stories can be specifically delivered to the client at a particular geographical location or to a client requesting information for a particular geographical location. In this embodiment, level 1, which is typically the broadest top level, can specify several different news codes. For example, level 1 can specify sections of news much like sections of typical newspapers, such as National Community, Business, Sports, Classified, Entertainment, etc. Subsequent levels after level one can be used to further characterize stories and customize the stories to a particular region. For example, if level 1 includes a section “sports”, level 2 can be used to specify stories for several different leagues such as professional, high school or even charity leagues. Level three can be used to specify schedules for the different leagues specified in level 2.

In an embodiment, this level system is called a parent-child level system. Every level after level 1 has a parent level. For example, if level 1 is charitable organizations, and level 2 is the American Red Cross, level 2 is the child of level 1, or said another way, level 1 is the parent of level 2. Child levels can be located at every geo-subject web site or at none of the geo-subject web sites. As a charitable organization, the American Red Cross would show up at every geo-subject web site across the country and across the world. However, a local organization in East Islip N.Y. would only be displayed in East Islip and in no other city.

The level system can be used in a variety of additional embodiments. In another embodiment, level 1 can be used to identify events at schools in the local community. Level 2 can be used to identify the type of school such as elementary, middle school or high school. Level 3 can be used to specify the name of a particular school. Level 4 can be used to identify a virtual classroom. Level 5 can be used to identify a particular teacher and the homework for the day or the week that the teacher has assigned. This information can be delivered to the same local geo-subject web page to where the local news stories are sent.

It is understood that none of the levels are limited to the embodiments set forth above. Many other news section types can be inserted into the different levels. Levels, besides being parent specific, that is subject specific, can also be geographically specific. Under a level 1 designated organizations, many national organizations can be listed such as the American Red Cross, the Rotary Club, etc., but local organizations can also be provided a level code that is specific to a given community.

The geo-subject news delivery method is also used to enter stories into database 303. The geo-subject database is a storage medium for all stories whether the story is of national interest such as Presidential elections, or of local interest such as a new Town Hall erected in Oneonta N. Y. Local users in a particular region are one source of news stories that will be displayed on the local geo-subject web page. Referring again to FIG. 5, the local user can post a story and specify the region of interest by using the state, county and city identifiers 515, 520, and 525. The level system sets the appropriate identifiers to place stories in the database 303 with the correct classification. For example, a user living in Leander Tex. wants to post a story about the team members on the Leander High School football team. The user simply needs to access the system feature that allows the user to upload a story to the database. The story is placed with the level codes for the region and is assigned a state code for Texas, a county code for Williamson county, and a city code for Leander. The user can then enter the story by subject and the location of the article using the level scheme will be placed in the correct area in the database. In an alternative embodiment, level 1 is used to specify sports. In the Leander Tex. example, the user can specify high school sports in level 2, and Leander High School in Level 3.

It is noted that local users are not the only source of news stories that are displayed on the local geo-subject web site. Any user at any geo-subject web site can post a story for any geo-subject web site region.

In another embodiment, stories can also be added to the database from news wire sources such as the Associated Press. Although the geo-subject database 303 is filled with stories entered by its local users, access to news wires allows the database to be updated with important national news. When a national story is posted in the geo-subject database 303, all geo-subject web sites attached to the database 303 will receive that National story. In this way, all the local geo-subject web sites will receive the most recent and important news around the country and around the world.

In an embodiment, each of the web sites contains a feature that allows a user to enter the stories with ease. A user can access this feature and be linked with a word processing program in which a story can be entered or uploaded, if previously written. The story will then be posted upon appropriate review (discussed below). In another embodiment, if a user wants to enter sports scheduling or score information, an appropriate program, such as a spreadsheet, can be accessed from the geo-subject web site. In another embodiment, a community calendar can be displayed that offers the same features as news story posting. For example, a user may add specific events to a particular community calendar so that all local users who access the calendar may see the upcoming events.

In the above-mentioned embodiments, news stories are posted, organized and delivered using the geo-subject method. In a particular embodiment, every geographical region stored in the database is assigned a geography code. For example, the following table shows city codes and county codes by state:

TABLE 3

| State | County Code | City Code |
|---|---|---|
| California | 301-400 | 3001-3500 |
| Massachusetts | 101-200 | 501-1000 |
| Pennsylvania | 701-800 | 19001-19500 |

Using this table, a story, advertisement or any other posted information posted from a specific geographic web site will be assigned a geographical code corresponding to the posting location. For example, a news article posted from Los Angeles Calif. is assigned the city code for Los Angeles 3245 and the county code 305 for Los Angeles county. An advertisement posted from Littleton, Mass. will be assigned the appropriate city code and the county code for Middlesex county A sports schedule posted from Philadelphia, Pa. will be assigned appropriate county and city codes. It is noted that the table represents only an example of geographical coding in a geo-subject database. Other embodiments are not limited to the states and the codes shown in the table.

In another embodiment, the number “0” is used to indicate an “all condition” delivery. That is, a geographic code of “0” is used to indicate that all pieces of information (e.g., articles, schedules etc.) relating to that coded category of geography are to be delivered. For example, if a user in California wants to obtain news articles for Santa Clara county, but for no specific city in the county, the users system in response to the user's request assigns a “0” for the city code and code 3401 for Santa Clara county. In this way, all news stories specific to every city in the county will be delivered. As another example, if a user in Boston Mass. wants all news stories concerning massachusetts delivered to him, the user's system in response to the user's request assigns a “0” for both the city and county codes.

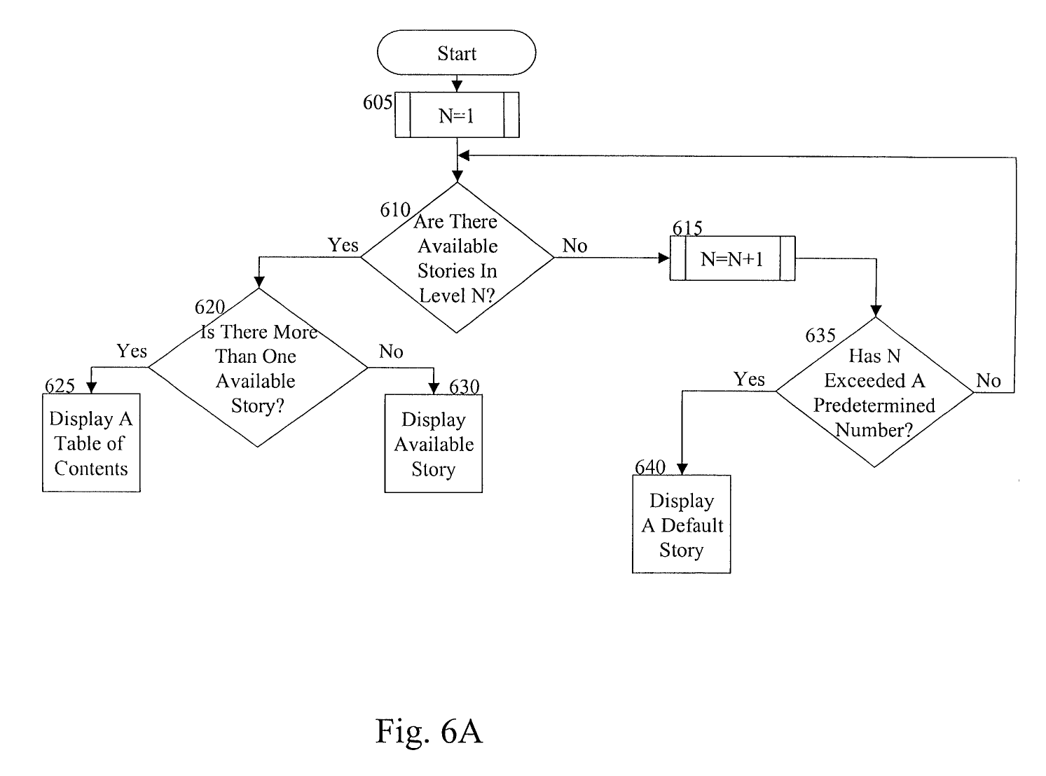

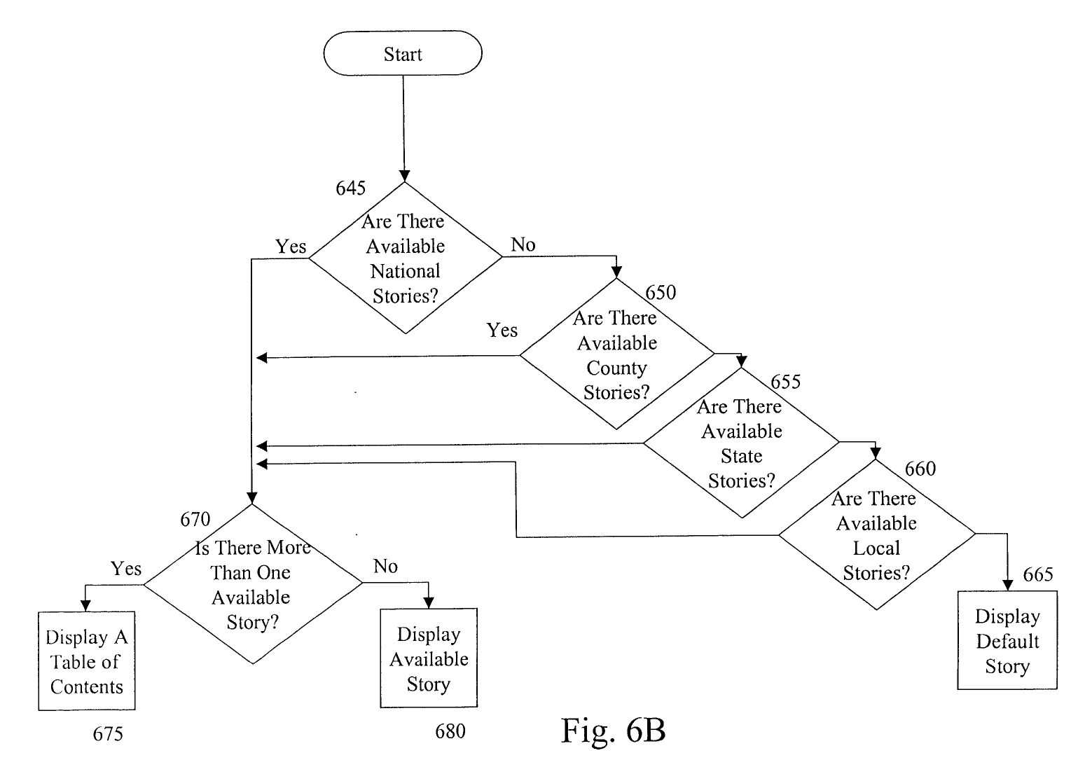

In an embodiment, a “floating story” feature ensures that there is always a story posted on a geo-subject web page. FIG. 6A illustrates a flow chart of an embodiment of a floating story method. When a geo-subject web page is launched a program searches for stories to display. In this embodiment, the stories are searched by level. The default level for any embodiment is level 1. N represents the number of levels. N is therefore initially set to be 1 at 605. The program searches level 1 for available stories at 610. If there are stories, the program checks to see if there is more than 1 story at 620. If there is more than one story then a table of contents is displayed at 625. A user is then free to choose any of the stories in the table of contents for viewing. If there is only one story then that story is displayed at 630. If there are no stories at the level N at 610, then N is indexed by 1 615 to search the next level at 610. This process continues to search subsequent levels for stories until a story or a table of contents is displayed. If no stories are discovered, for example, if a new geo-subject web site just began operation, then a default story. If a certain level number N is exceeded at 635, then the default story is displayed at 640. In an embodiment, the default story can be a story about the geo-subject web site explaining to users how to submit stories. If N has not exceeded this number then the search continues at 610.

In an alternative embodiment, the floating story method enables stories to be floated and displayed by searching levels by geography. FIG. 6B illustrates an embodiment of a floating story by geography method. First, the program searches for national stories to post at 645. National stories can be, but are not limited to, local stories of interest or national headline stories. If there are no national stories, the program searches for state stories to display at 650. If there are no state stories then the program searches for county stories to display at 655. If there are no local stories, then a default story is displayed. In an embodiment, the default story can be an informative story concerning technical updates to the geo-subject web site. At any of the search junctions 645, 650, 655, 660, if there are available stories, the program checks to see if there are more than one story at 670. IF there is more than one story, a table of contents is displayed at 675. If there is just one story, that story is displays at 680.

At each local client set up to receive local news stories, all stories above the local level will be posted at the local geo-subject web site. For example, in West Lafayette Ind., the local geo-subject web site has several sections set up such as news, sports, entertainment, etc. Under the news section, the default settings will list all national, statewide, and county-wide stories in addition to the local stories of interest. If there are several stories at each of these geographic levels, then a table of contents appears. If there is only one story, then the story is displayed. If at the highest default level, for example a level indicating local stories of national interest, there is no story, then the levels below are searched for other stories to display. The story that is chosen for display is the story that has been most recently submitted. This story is identified and floats to the top for display. In an embodiment, if there are more than one story that can be displayed, then a table of contents is displayed. Additional lower levels can be searched if there are no recent stories available for display at higher levels. This floating story scheme is used in order to always keep a story displayed on the local geo-subject web site. In the West Lafayette Ind. example, if there are no national, county, or state wide stories available then the default story displayed on the local geo-subject web site may be the news report for the Tippecanoe county High School football game over the week end. In an embodiment, the most recent entered story in the database is the story that is posted on the first page of the local geo-subject web site, and any further stories that float to the top are the most recently posted stories.

Since the geo-subject news delivery method allows all users of client on the geo-subject web page to post upload stories into the database 303 and therefore freely post news stories, an embodiment of the method allows a network web page administrator of the server to review the posted news stories for content appropriate to the web site. In this way, pornographic, libelous, or otherwise inappropriate material can be filtered out of the news story before the story is posted.

In another embodiment, certain trusted users of the geo-subject method are allowed to freely post stories. Trusted users are typically school teachers, noted freelance writers, noted columnists and the like. Each of the trusted users is given a unique user name and password that permits secure access.

The number of geo-subject web sites local to specific communities is virtually limitless. Users are free to set up their own geo-subject web site whether it defaults to a national news page, a local news page, or even a local high school track team Fall schedule page.

In a number of embodiments, the typical default geo-subject web page is a city news web page. This web page can contain information of interest to most users such as horoscopes, lottery numbers, weather, and high school information. In alternative embodiments, a college can be considered a city for the purpose of geo-subject news delivery. Since a college campus tends to have its own society, this embodiment allows users interested only in college news, sports, social events and the like to set up a default geo-subject web site specific to a college campus. In this embodiment, the web site can not only contain information of interest to all similar to the city web page, such as weather, lottery numbers, but also scores for the school teams as well as the latest financial aid information, dormitory room availability and the course schedule for the upcoming semester.

### DELIVERY OF ADVERTISING

The delivery of advertising is accomplished using the geo-subject delivery method. Advertisements are therefore directed to the local region of interest. For example, a shoe store owner in Joliet Ill. is able to target his shoe advertisements only to geo-subject web pages defaulted to Joliet Ill. As another example, a local advertiser can even target his advertisements to one specific classroom for one specific teacher in a high school if the advertiser desires to do so.

In an embodiment, delivery of advertising adds to additional levels of complexity to the geo-subject delivery method. In this embodiment, when a geo-subject web page is opened, one or more advertisements will be displayed on the web page along with any information and news that the user in which the user is interested in viewing. Several different advertisers, whether local entities or more national/international entities are identified as wanting to advertise on the geo-subject web page. Therefore, when a web page is opened there are several different advertisements that can be displayed in a limited number of advertising spots. The geo-subject delivery method's added levels of complexity create a scheme which introduces criteria that allows a logical display criteria in the limited advertising space. The scheme allows a logical display of multiple advertisements and a way of preventing a user from seeing one advertisement continuously. When delivering the advertising to the web page the server delivers the advertising considering the amount of money paid for the advertisement, and the density of which the advertise desires its advertisement to be viewed. Advertising is purchased at a given cost and density. Cost represents the cost per impression for the advertisement. Density represents the maximum percentage that the advertiser wants their advertisement to be seen by the same user. As an example of cost per impression, user 1 in Portland Me. launches his web page, and advertisement A is displayed in one advertising spot. User 2 in Portland Me. also launches her web page and advertisement A is also displayed. For those two displays of advertisement A, that advertiser pays a set cost for each of those advertisement impressions. However, user 1 then refreshes his web page and advertisement B is displayed at a set cost to that advertiser. Advertisements are listed in order the order of which advertiser paid the most for the advertisement impression. The most expensive advertisement is displayed first. The next highest paid advertisement is displayed next. In an embodiment, the highest-paid-advertisement-first scheme creates a bidding system in which advertisers bid for the advertisement spot.

Cost is the first level of complexity for the geo-subject delivery of advertising. Density is also considered. As discussed previously, density is the maximum percentage that the advertiser wants their advertisement to be seen by the same user. In an embodiment, a single advertisement space on a web page has ten advertising spots. As a simple example illustrating the density and cost relationship in the delivery of advertising consider the following ten advertisers who paid various cost for the ad spot but who all wanted the same advertising density:

TABLE 4

| | Cost for | |
|---|---|---|
| Advertiser | Advertisement | Density |
| 1 | $0.20 | 0.10 |
| 2 | $0.18 | 0.10 |
| 3 | $0.15 | 0.10 |
| 4 | $0.14 | 0.10 |
| 5 | $0.10 | 0.10 |
| 6 | $0.09 | 0.10 |
| 7 | $0.08 | 0.10 |
| 8 | $0.05 | 0.10 |
| 9 | $0.02 | 0.10 |
| 10 | $0.01 | 0.10 |

If a user in Clermont Ga. refreshes her web page ten times, she sees the advertisers' ad in the order of who paid the highest. Each advertiser is considered for display in the advertising spot based on the density that the advertiser requests. When a web page refreshes or is updated, a new advertisement is considered to be displayed in the spot. If an advertiser has requested a density of 10%, that advertisement will only be considered to be displayed once every ten updates. If an advertiser has requested a 50% density, then that advertisement will be considered for display every other update. If an advertiser has requested a 100% density, then this advertisement will be considered for display on every update. Any number of advertisements can be contained in a set. The number of advertisements in the set limits the density that an advertiser can choose. For example, if the advertisement set is ten, then the advertiser can only choose densities: 0.10, 0.20, 0.30, 0.40, 0.50, 0.60, 0.70, 0.80, 0.90, and 1.00. If the set is only five advertisements, then the individual advertisers are limited to the densities: 0.20, 0.40, 0.60, 0.80, and 1.00.

Referring now to FIG. *** a flow chart for an embodiment of an advertising display scheme . . .

In operation, therefore a user of a geo-subject web site launches the first page of an information program site, the page having a unique identifier. The news is delivered specific to that geo-subject identifier (the news can be generic to all geographies for the initial specific subject identifier). A set of advertisements are delivered to the program that is delivering the page to the user (the quantity of advertisements is determined by the minimum density that the geo-subject program chooses to use (a 5% minimum density would require a delivery of 20 advertisements, a 20% minimum density would require a delivery of 5 advertisements). This advertisement set is ordered by the price the advertiser has chosen to pay, the most expensive advertisement first. Each advertisement is considered for delivery until one advertisement is selected. The advertisement is delivered and displayed to the user. The remainder of the set is discarded. The process used to select an advertisement starts with the most expensive advertisement which, if has already been seen and thus would exceed the density level the advertiser has selected, the advertisement is bypassed for the second highest priced ad, etc. This process creates two primary scenarios. First, the local advertiser can out bid the national advertiser and always be seen first; and at the same time, control the advertisement costs by limiting the frequency a given viewer sees the advertisement. Second, the national advertiser can purchase advertising across geographies subject-specific or even “run of the paper” (“ROP”). In their case, they may bid low for a given advertisement but request a high density, such as 100%. By choosing such a low bid and high density, this does not guarantee that their advertisement is seen, it does guarantee that it is in the list considered for display. Their advertisement appears when no other, more expensive, advertisement is in front of it in the set.

In a particular embodiment, the advertisements in a set that are considered for display are placed in an “exclude” array once they have been viewed. The advertisement is removed from the exclude array when certain criteria are met. These criteria are discussed in further detail below. As discussed above, any number of advertisements can be considered in a set. For convenience of discussion, a set of ten advertisements is discussed in one embodiment and a set of five advertisements is discussed in another embodiment.

In general, N advertisements can be considered for display on a geo-subject web page. The advertisements which have been assigned an advertisement key when they first were uploaded, and are placed in a one dimensional array having N elements. The advertisers also choose a density and a price for each of their advertisements. The following table illustrates a set of ten advertisements that are to be displayed on a geo-subject web page. The position in the array is determined by the price bid for the advertisement. The highest paid advertisement appears in the first set position, the second highest cost advertisement is placed in the second array position and so on. The product column represents the product of the array position and the density. The table represents the first instance of a display on a geo-subject web-page:

TABLE 5

| Ad Key | Price | Position in Set | Density | Product |
|---|---|---|---|---|
| 152 | 1.00 | 1 | 0.20 | 0.20 |
| 638 | 0.93 | 2 | 0.30 | 0.60 |
| 363 | 0.87 | 3 | 1.00 | >1 |
| 262 | 0.81 | 4 | 0.10 | 0.40 |
| 363 | 0.75 | 5 | 0.20 | 1.00 |
| 277 | 0.69 | 6 | 0.10 | 0.60 |
| 236 | 0.58 | 7 | 1.00 | >1 |
| 162 | 0.55 | 8 | 0.20 | 1.60 |
| 166 | 0.54 | 9 | 0.10 | 0.90 |
| 845 | 0.53 | 10 | 0.30 | >1 |

In this set, the highest cost advertisement, ad key 152, is displayed when the web-page is first launched. This advertisement is then placed in the first position in the exclude array. On the next refresh of the web page, the next most expensive advertisement, ad key 638, is displayed. This advertisement is placed in the first position in the exclude array, and ad key 152 is shifted to the second position in the exclude array:

TABLE 6
Exclude Array

| Position | Ad Key | Density | Product |
|---|---|---|---|
| 1 | 638 | 0.30 | 0.30 |
| 2 | 152 | 0.20 | 0.40 |

The product of the array position and the density determines whether or not the advertisement is retained in the exclude array. When the product is less than or equal to “1”, the advertisement is retained in the exclude array. When the product is greater than “1” the advertisement is removed from the exclude array and can thus be displayed again when it qualifies. As stated above the 100% densities are for those advertisers who buy their advertisements on a ROP basis where they are bidding a low cost on the premise that there is a geographic/level combinations that have no higher price advertisements or that those higher price advertisements are unavailable because of the exclude array.

Referring still the above table, on the next refresh of the web page, the next most expensive advertisement, ad key 363, is displayed. Ad key 363 is then placed in the exclude array and the other advertisements are appropriately shifted:

TABLE 7
Exclude Array

| Position | Ad Key | Density | Product |
|---|---|---|---|
| 1 | 363 | 1.00 | 1.00 |
| 2 | 638 | 0.30 | 0.60 |
| 3 | 152 | 0.20 | 0.80 |

The advertiser who submitted the advertisement with ad key 363 chose a 100% density. Therefore, ad key 363 immediately has a product of “1” and is removed from the exclude array and placed back in the set for display consideration in the next refresh. The products for ad keys 638 and 152 are still less than “1” and therefore remain in the exclude array. During the next refresh ad key 363 is displayed once again because it has been removed from the exclude array, and because it is the most expensive advertisement under consideration for display. Further details concerning the exclude array is discussed below.

The placement of advertisements in the exclude array creates a bidding war between advertisers. If an advertiser does not bid high enough, that advertiser will be placed in a low position to be displayed. In order for the advertisement to be displayed, the advertiser must pay a higher cost for the advertisement.

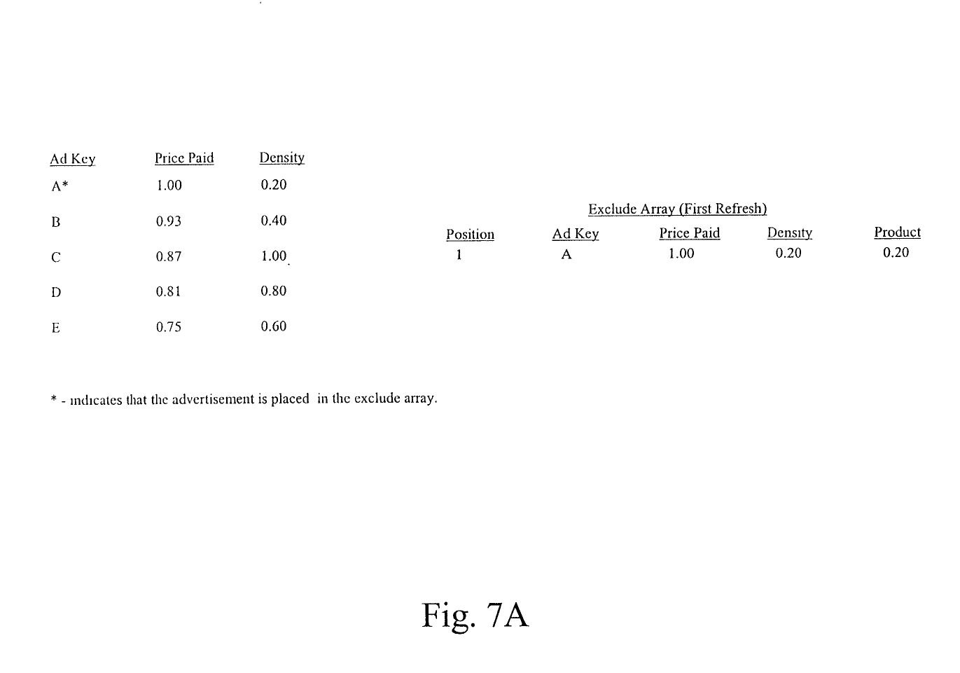

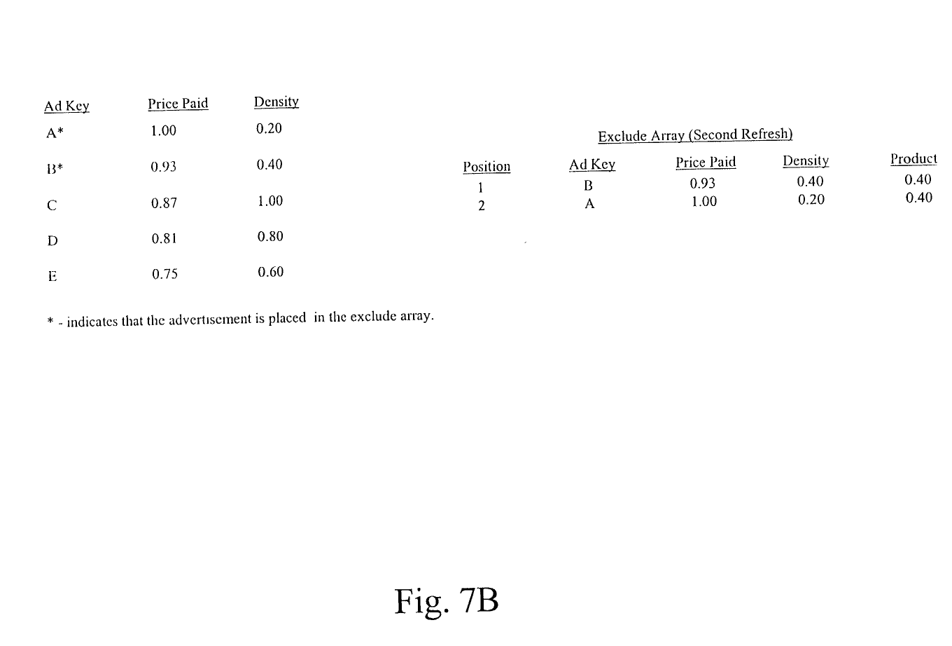

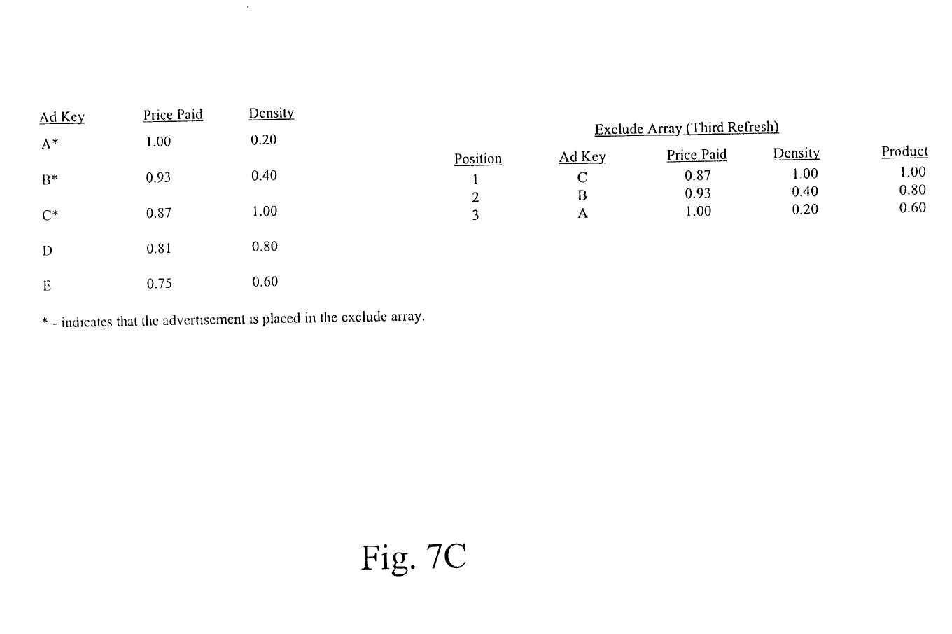

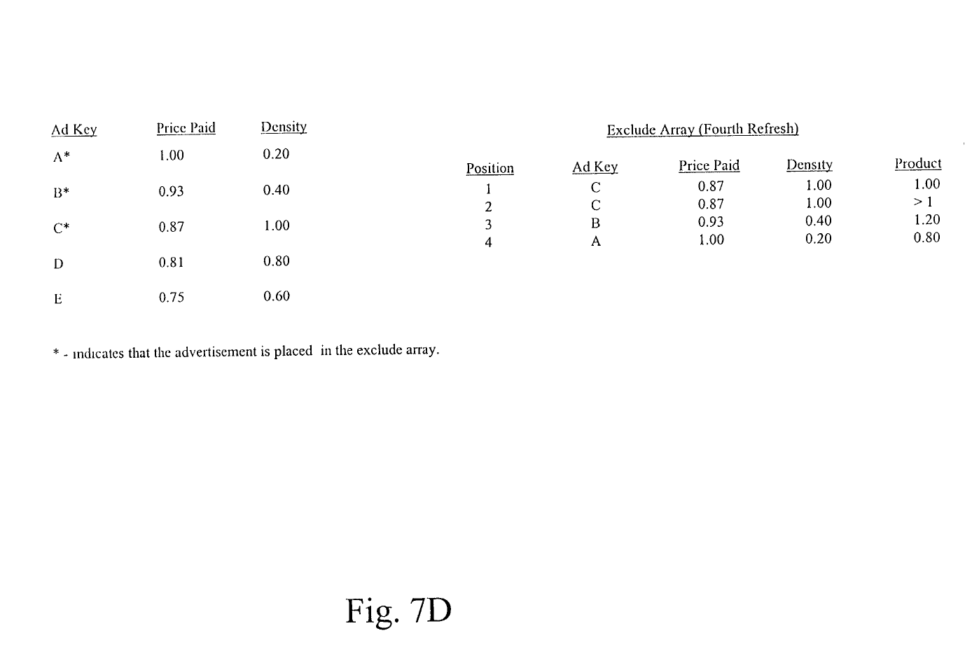

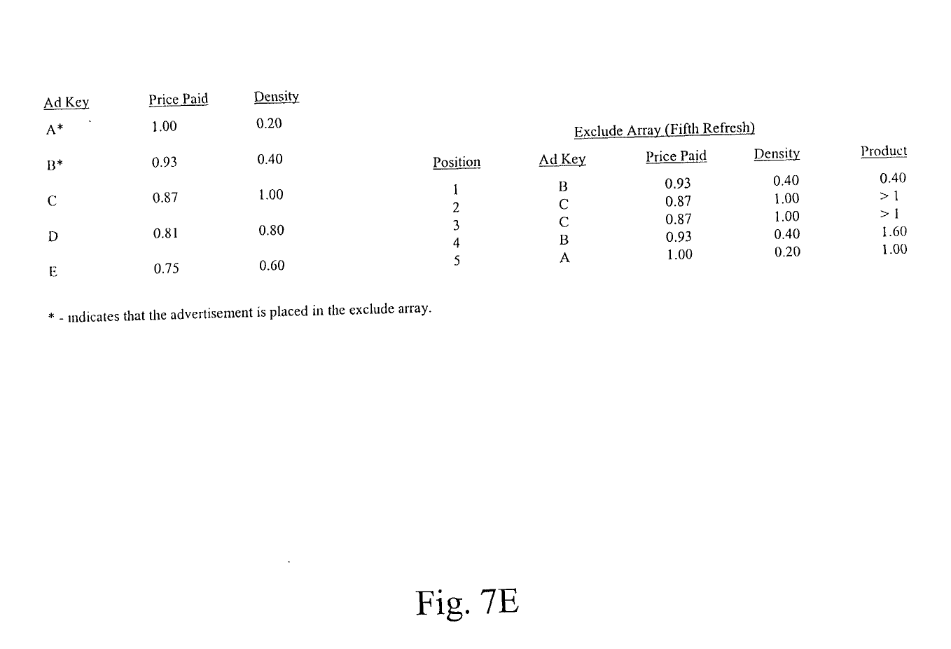

FIGS. 7A-7E illustrate an embodiment of a rotation sequence of a set of five advertisements that can be displayed in an advertisement spot on a geo-subject web page. FIG. 7A illustrates an set of five advertisements A, B, C, D and E. When a web page is initially opened in this embodiment, advertisement A is the most expensive, and therefore it is displayed. Advertisement A is then placed in exclude array in position 1. The product of position and density is calculated to be 0.20.

FIG. 7B illustrates the same set of five advertisements. In this case when the web page is refreshed, advertisement B is displayed because it is the next most expensive advertisement. Advertisement B is then placed in the exclude array in position 1. Advertisement A is shifted to position 2. The respective products of A and B are 0.40 and 0.40. Both advertisements A and B have products less than “1” and thus remain in the exclude array.

FIG. 7C illustrates the same set of five advertisements as they appear during a subsequent refresh of the web page. Advertisement C is the next most expensive advertisement and is therefore displayed, then placed in the exclude array in position 1. Advertisements A and B are shifted to positions 3 and 2 respectively. The products of C, B and A are 1.00, 0.80 and 0.60 respectively. It is noted that since advertisement C has a density of 1.00 (100% exposure), it already qualifies to be removed from the exclude array. Advertisements A and B still do not qualify to be removed from the exclude array because their products are still less than “1”.

FIG. 7D illustrates the same set of five advertisements during the next refresh of the web page. As stated above, advertisement C is removed from the exclude array and is considered for display. Since A and B are still in the exclude array, the only advertisements considered for display are C, D and E. Advertisement C is again the most expensive advertisement, and is therefore displayed once again, and placed in the exclude array. The figure illustrates that advertisement C is in positions 1 and 2. Since C has just been displayed, it is placed in the first position of the exclude array. The presence of C in another position simply indicates that advertisement was once placed at that position and occupies the position to achieve uniformity in the array. Since the product for advertisement C is again 1.00, it qualifies for removal from the exclude array. Advertisement B also now qualifies to be removed from the exclude array because its product is 1.20.

FIG. 7E illustrates the same set of five advertisements during a next refresh of the web page. All of the advertisements except advertisement A are considered for display. In this situation, the most expensive advertisement is advertisement B which is displayed and placed back into the exclude array. Advertisement A now qualifies for removal from the exclude array for two reasons. The first reason is that it has a product greater than 1. The second reason is that advertisement A “falls out” of the array because there are no more positions into which it can be shifted. During the next refresh (not shown) advertisement A is the most expensive advertisement, and thus it is displayed.

This rotation will continue for as many times as the page is refreshed and so long as the advertisers pay for the hit. It is noted that advertisements D and E are never displayed. These two advertisements never qualify for display because the advertiser did not pay enough money for their advertisements to have a higher position in the set. This process thus encourages the advertisers to bid higher for a better position, and therefore creates the bidding war as discussed above. It is also noted that the choice of 100% density for advertisement C guaranteed more displays than the advertisements with lower densities. Each time advertisement C is displayed and placed in the exclude array, it immediately qualifies for removal because its product will always be “1” when placed in the first array position. Advertiser C therefore does not have to necessarily pay the highest bid to have good exposure to the geo-subject web site user.

Since advertisers are paying for the advertisement impression each time the impression is displayed, the advertiser needs a way to pay the web page administrator. In an embodiment, an account is setup up in which an advertiser pays an amount into the account, and each time the advertisement is displayed the account is debited.

In another embodiment, at least one additional advertising space can be added onto the web page. The additional advertising space can be bought based on a set price and one advertisement can remain the only advertisement in that space for a set period of time, such as a week. Therefore, whenever a particular user refreshes that web page, the same advertisement is displayed each time. Every time the user opens or refreshes that web page that same advertisement is displayed (for the period of time for which the advertiser paid).

Since the geo-subject advertisement delivery method allows all users of client on the geo-subject web page to upload into the database 303 and therefore freely post advertisements, an embodiment of the method allows a network web page administrator of the server to review the posted advertisements for content appropriate to the web site. In this way, pornographic, libelous, or otherwise inappropriate advertisements can be filtered before the advertisement is accepted. Since the advertisements can be targeted to specific geo-subject web sites, additional control and authority can be delegated to certain users to further control advertising. For example, the various school and youth organization sections can be monitored by the appropriate authority in order to filter advertisements not suitable for young people. An advertisements for the local tavern and pool hall is not suitable for display in the elementary or high school sections of a local geo-subject web site. Therefore, an appropriate governing body such as a school principal can exclude those advertisements from the school sections.

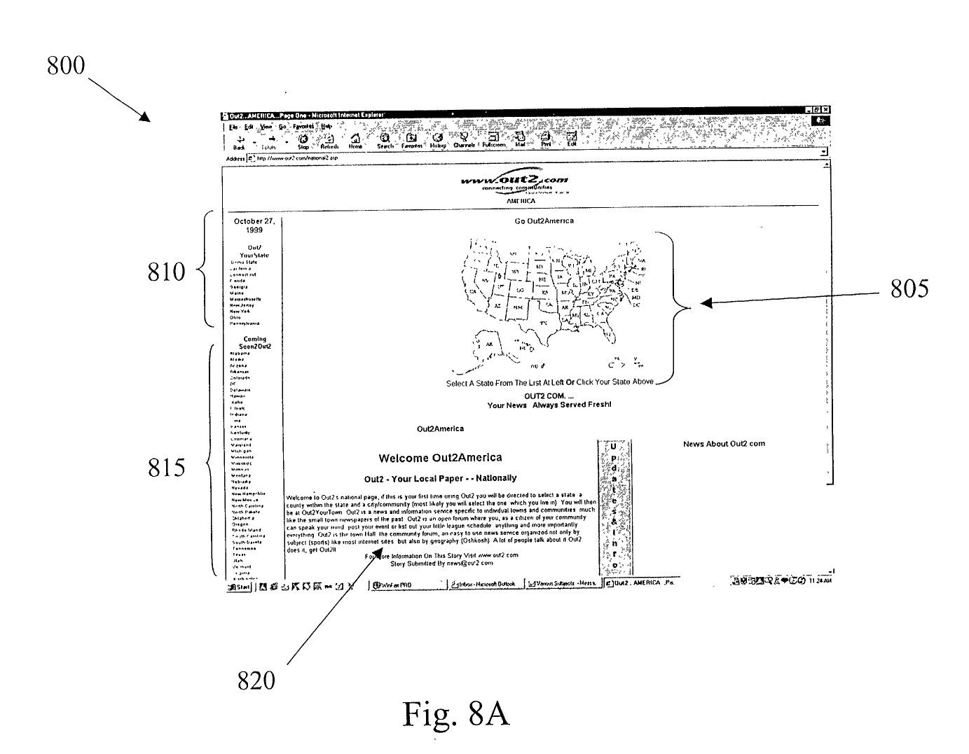

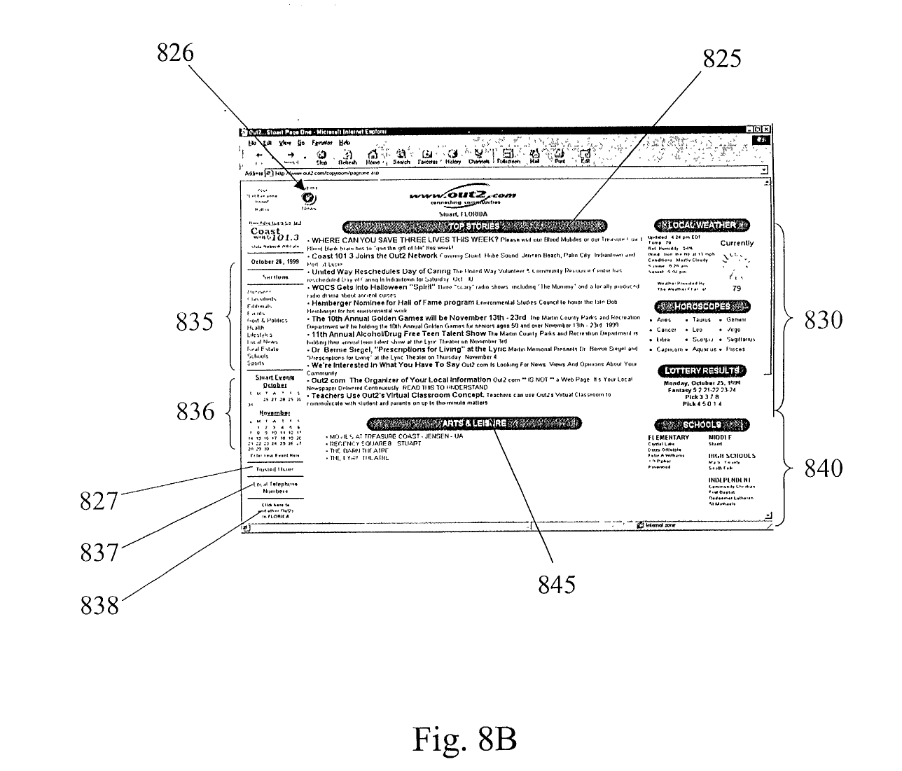

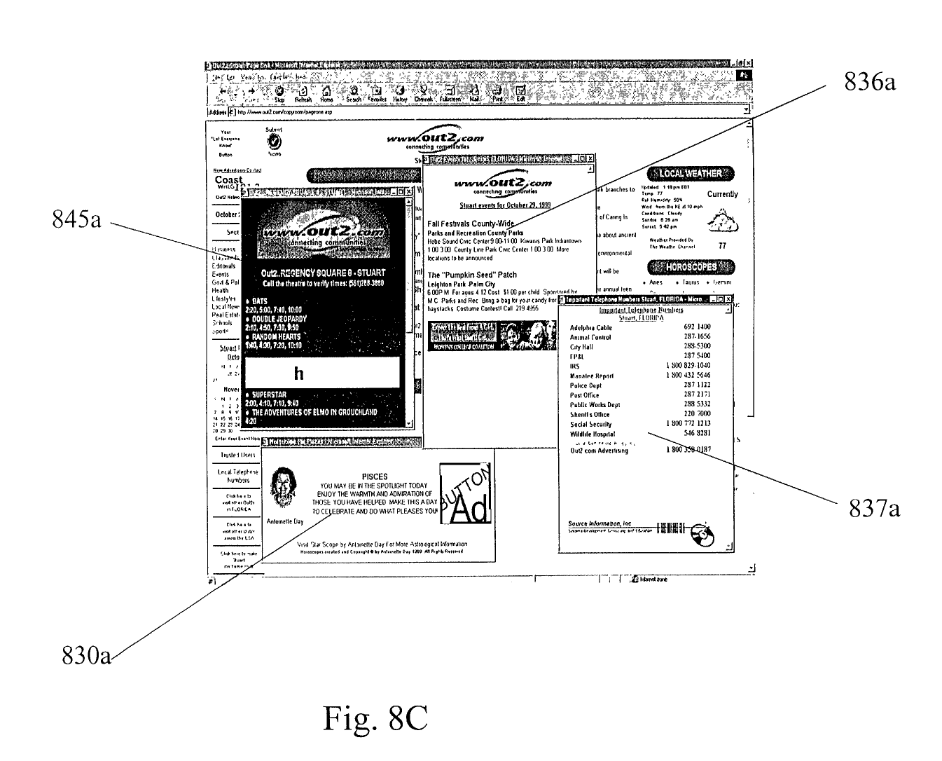

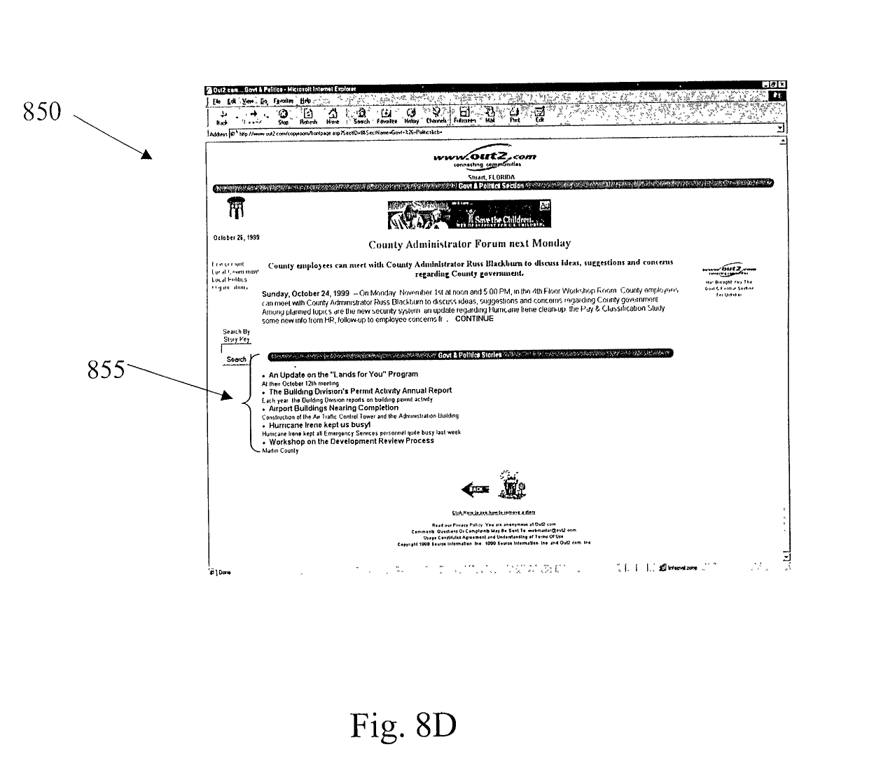

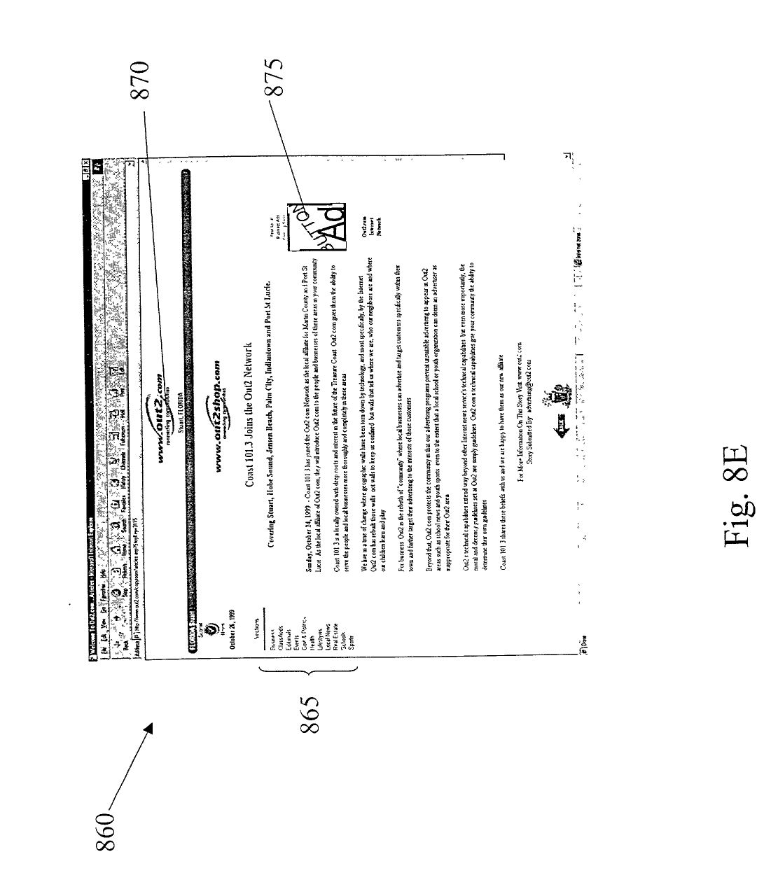

Several embodiments have been discussed above in the context of flow charts and algorithms. FIGS. 8A-8B illustrate several screen shots of implementations of a geo-subject web page.

In an embodiment, when a user first enters a geo-subject web site, an overview page will be displayed. Referring to FIG. 8A, in one implementation, a user enters a geo-subject web site and a web page 800 an overview the United States 805. The user can choose any of the states listed 820 or displayed 805 to launch a geo-subject web page specific to the state of interest. If there are further states to be added at a later date, a listing of those states 815 is provided. Any updates or information 820 that is of interest to geo-subject web site users is also displayed. It is understood that other embodiments are not limited to displaying the United States. For example, in another embodiment, a world map can be displayed showing different countries in which geo-subject web pages specific to those countries can be launched. In other embodiments, different countries can be displayed, listing individual states or provinces within those countries.

When the user chooses a state from the display 805 or list 810, she has options to choose a county and city of her choice to be displayed as her default geo-subject web page. When she chooses the web page as her default geo-subject web page, the geographic cookies are replanted as discussed above. FIG. 8B illustrates a screen shot of an implementation of a local geo-subject web page. This web page displays the local information for Stuart Fla. On this web page the top stories 825 are displayed. The stories are display according to the floating story methods described above. Any one of the stories listed in the section 825 can be displayed by the user. News stories are submitted by choosing the submit news option 826. When this option is chosen, a user-interface is displayed to aid the user is posting the story to the database 303. Trusted users are able to enter stories in the trusted users section 827. The web page can also display specific sections by choosing from a section list 835. Local interests such as weather, horoscopes and lottery results are also displayed 830. A school section 840 is available to access information about local schools. An events calendar 836 is also displayed. A user can choose any day on the calendar 836 and the local events for that day are listed. An arts and leisure section 845 is displayed. This section 845 is accessed to display local theater listings, local plays, local musicals, etc. A section 837 of important phones numbers is also displayed. The user can also access other local geo-subject web pages in an access section 838. The access section 838 allows the user to set the local geo-subject web page as default.

FIG. 8C illustrates the same screen shot in FIG. 8B. FIG. 8C further illustrates four “pop-up” screens 830a, 836a, 837a and 845a. Horoscope screen 830a is displayed when the horoscope from the local interest section 830 is accessed. Events screen 836a for a particular day can be displayed when the events calendar 836 is accessed. Phone numbers screen 837a is displayed when the phone numbers section 837 is accessed. Theater schedule screen 845a is displayed when theater information is accessed from the arts and leisure section 845. It is understood that the screens 830a, 836a, 837a and 845a are only examples of the screens that can be displayed. In other implementations, more screens can be displayed from additional sections located on the geo-subject web site.

FIG. 8D illustrates a screen shot of a section of web page 850 that can be displayed when the section list 835 is accessed. In the figure, the local Government and Politics section is displayed listing various news stories 855.

Referring again to FIG. 8B, a news stories section 825 in which several stories were listed is displayed. One story “Coast 101.3 Joins the Out2 Network” can be accessed by a user and displayed as shown in FIG. 8D, which is an implementation of a news story web page 860. The user can also access other sections 865 from this web page. Two advertisement sections 870, 875 are also shown on this web page. The first advertisement section 870 illustrates an embodiment of the type of advertising which rotates a set of advertisements by price and density as discussed above with respect to the delivery of advertisements. The second advertisement section 875 illustrates an embodiment of an advertisement that can be displayed for a set period of time (e.g., one week) for a set price as discussed above. It is understood that other implementations of news story displays are not limited to the implementation of the screen shot shown in FIG. 8E.

Further implementations of geo-subject information delivery, including news stories and advertisements, are not limited by any of the embodiments discussed.

The methods described above can be implemented in digital electronic circuitry, or in computer hardware, firmware, software, or in combinations of them. Apparatus of the invention may be implemented in a computer program product tangibly embodied in a machine-readable storage device for execution by a programmable processor; and method steps of the invention may be performed by a programmable processor executing a program of instructions to perform functions of the invention by operating on input data and generating output. The invention may advantageously be implemented in one or more computer programs that are executable on a programmable system including at least one programmable processor coupled to receive data and instructions from, and to transmit data and instructions to, a data storage system, at least one input device, and at least one output device. Each computer program may be implemented in a high level procedural or object-oriented programming language, or in assembly or machine language if desired; and in any case, the language may be a compiled or interpreted language. Suitable processors include, by way of example, both general and special purpose microprocessors. Generally, a processor will receive instructions and data from read-only memory and/or a random access memory. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD_ROM disks. Any of the foregoing may be supplemented by, or incorporated in, specially-designed ASICs (application-specific integrated circuits).

Other implementations are in the scope of the following claims.

What is claimed is:

1. A computer-implemented electronic information delivery method, comprising:
providing a computer system adapted to be connected to a network;
providing a database of information on the network; and
providing a delivery engine on the computer, wherein the delivery engine delivers data from the database to the computer based on a user-selectable request.

2. The method of claim 1 wherein the user-selectable request is a request for the information stored in the database and which is applicable for a geographical location.

3. The method of claim 1 wherein the user-selectable request is a request for the information stored in the database and which is applicable for a particular subject.

4. The method of claim 1 wherein information stored in the database is stored by at least one data structure.

5. The method of claim 4 wherein the data structures are comprised of a plurality of parent-child levels corresponding to a plurality of subjects.

6. The method of claim 2 wherein cookies planted on the computer from a information delivery software program geographic information on the computer according to the user-selectable request.

7. The method of claim 6 wherein cookies are replanted if the user changes the user-selectable request.

8. The method of claim 1 wherein information comprises a plurality electronic news stories and other news-related electronic information.

9. The method of claim 1 wherein information comprises a plurality of electronic advertisements.

10. A computer-implemented method of displaying advertisements at a computer, comprising:
providing at least one advertisement on each displayed web page each time a user refreshes the web page, wherein each advertisement is retrieved from a database containing a plurality of advertisements; and
selecting the displayed advertisements in accordance with a cost paid per impression and a density requirement.

11. The method of claim 10 wherein providing an advertisement on the web page comprises:
changing advertisements on the web page each time the web page is refreshed.

12. The method of claim 11 wherein the displayed advertisements are alternated depending on the cost of the advertisement.

13. The method of claim 11 wherein the advertisements are alternated depending on the density of exposure of the advertisement.

14. The method of claim 11 wherein the advertisements are alternated depending on the cost and density of exposure of the advertisement.

15. The method of claim 10 further comprising delivering the advertisements to the computer according to the geographical location of the advertisement.

16. The method of claim 10 further comprising delivering the advertisements to the computer according to a particular subject.

17. The method of claim 10 further comprising delivering the advertisements to the computer according to a geographical location of the computer and a particular subject.

18. The method of claim 14 further comprising:
placing advertisements that have already been displayed into a data structure located in the database; and
retaining the advertisements in the data structure until the advertisements attain pre determined criterion.

19. The method of claim 18 wherein the criterion is a product of the position in the data structure and a quantitative representation of the density of exposure.

20. A computer-implemented method of delivering selected electronic news stories from a database storing the stories to a computer for displaying the selected stories, comprising:
establishing a connection between the computer and the database through a network;
delivering the selected stories from the database, wherein the stories are delivered according to user-selectable criteria including at least one geographic location data; and
displaying the news stories on the computer.

21. The method of claim 20 wherein one user-selectable criterion is a specification of at least one geographical location to which the news stories pertain.

22. The method of claim 20 wherein one user-selectable criterion is a specification of at least one news story subject.

23. The method of claim 20 wherein displaying the news stories on the computer further comprises:
displaying a plurality of default news stories if there are no news stories that match to the user's identified user-selectable criteria.

24. A computer program residing on a computer-readable medium comprising instructions for causing a computer system adapted to be connected to a network to:
provide a database of information on the network;
provide a delivery engine on the computer, wherein the delivery engine delivers data from the database to the computer based on a user-selectable request

25. The computer program of claim 24 wherein the user-selectable request is a request for the information stored in the database and which is applicable for a geographical location.

26. The computer program of claim 24 wherein the user-selectable request is a request for the information stored in the database and which is applicable for a particular subject.

27. The computer program of claim 24 wherein information stored in the database is stored by at least one data structure comprising a plurality of parent-child levels corresponding to a plurality of subjects.

28. The computer program of claim 24 further comprising instructions to:
plant cookies on the computer from a information delivery software program geographic information on the computer according to the user-selectable request.

29. The computer program of claim 28 wherein cookies are replanted if the user changes the user-selectable request.

30. The computer program of claim 24 wherein information comprises a plurality electronic news stories and other news-related electronic information.

31. The computer program of claim 24 wherein information comprises a plurality of electronic advertisements.

32. A processor-based apparatus comprising:
a processor;
a first memory operationally coupled to the processor;.
a second memory operationally coupled to the processor, the second memory storing instructions to:
provide information stored in the first memory to a network connected to the apparatus;
deliver the information from the first memory to the network based on a user-selectable request.

33. The apparatus of claim 32 wherein the first memory is a database.

34. The apparatus of claim 32 wherein the second memory is a hard disk.
